(19) United States
(12) Patent Application Publication
(10) Pub. No.: US 2005/0226617 A1
(43) Pub. Date: Oct. 13, 2005

(54) Digital image transmitter

(76) Inventors: Seung-Il Lee, Suwon-city (KR); Jong-Kuk Mun, Suwon-city (KR); Jong-Ho Choi, Seoul (KR)

Correspondence Address: CANTOR COLBURN, LLP, 55 GRIFFIN ROAD SOUTH, BLOOMFIELD, CT, 06002, US

(21) Appl. No.: 10/989,681

(22) Filed: Nov. 15, 2004

(30) Foreign Application Priority Data
Mar. 31, 2004 (KR) 2004-22358

(51) Int. Cl. H04J 14/02

(52) U.S. Cl. 398/79

(57) ABSTRACT

A digital image transmitter is disclosed herein. The digital image transmitter includes: a sender for transforming a plurality of channels of electrical signals output from a computer to a single channel of optical signal and sending the single channel of optical signal; an optical cable provided with a single optical fiber and sending the single channel of optical signal of the sender through the optical fiber; and a receiver for recovering the single channel of optical signal transmitted through the optical cable to the plurality of channels of electrical signals and outputting the electrical signals to a digital image display device. Therefore, the present invention is capable of increasing productivity and reducing manufacturing and installation costs by simplifying a manufacturing process. Further, the present invention is capable of stably transmitting a high-resolution digital image signal since the skew does not generated during long distance transmission.

### CROSS-REFERENCE TO RELATED APPLICATION

This application claims the benefit of Korean Patent Application No. 2004-0022358, filed Mar. 31, 2004, the disclosure of which is hereby incorporated herein by reference in its entirety.

### BACKGROUND OF THE INVENTION

1. Field of the Invention

The present invention relates to an image transmitter and, more particularly, to a digital image transmitter for transmitting a high quality of digital image signal.

2. Description of the Related Art

Generally, image signals output from a computer use an analog type and a digital type. The computer outputs analog image signals when a monitor connected thereto is a CRT type, and digital image signals when an LCD type.

Meanwhile, the LCD monitor has come into wide use in recent years as users' need of the LCD monitor is gradually increased, therefore, a digital image transmitter capable of transceiving the digital image signals between the computer and the LCD monitor also has come into wide use.

The digital image transmitter for transceiving the digital image signals employs a digital visual interface (DVI) type or a high definition multimedia interface (HDMI) type, and at this time, the digital image signals includes four channel signals, i.e., red (R), green (G), blue (B) and reference signal clock (C).

However, since the digital image signals are a high frequency of about several hundreds MHz˜several GHz, when a distance between the computer and the LCD monitor becomes more than about 5 m, there is a problem that the signals does not very well transmitted due to signal attenuation and noise generation.

Conventional technologies have attempted to overcome this problem by employing a digital image transmitter provided with an optical cable and an optical connector having little signal attenuation and noise generation during long distance transmission of the digital image signals.

FIG. 1 is a view illustrating a conventional digital image transmitter.

As shown, the digital image transmitter includes a sender 1 connected to a computer 10, a receiver 2 connected to an LCD monitor 20, and an optical cable 3 for connecting the sender 1 and the receiver 2.

And more specifically, the sender 1 is provided with a sending connector 11, four laser drivers 12, and four laser diodes 13; the receiver 2 is provided with four photo diodes 21, four signal amplifier 22, and a receiving connector 23; and the optical cable 3 is provided with four optical fibers.

Each of the four laser drivers 12 of the sender 1 receiving electrical signals of the four channels output from the computer drives the corresponding laser diodes 13 to transform the electrical signals to the optical signals, respectively. That is, the sender 1 transforms the four channel electrical signals to the four channel optical signals.

The transformed four channel optical signals are long distance transmitted through the four optical fibers 3, the four photo diodes 21 of the receiver 2 recover the transmitted optical signals to electrical signals, and the signal amplifier 22 amplifies the electrical signals having a weak voltage to a voltage level that the LCD monitor 20 can recognize.

As a result, the four channel electrical signals output from the computer 10 are transmitted to the LCD monitor 20, and the LCD monitor 20 displays the received four channel electrical signals, i.e., the digital image signals, on a screen.

As described above, the conventional digital image transmitter transforms the digital image signals includes the four channel electrical signals, i.e., R, G, B and C, to the four channel optical signals through one-to-one transformation, and the four channel optical signals are transmitted through the four optical fibers 3.

However, the conventional digital image transmitter requires four channel optical fibers in order to transmit the digital image signals, therefore, its manufacturing process becomes complicated and its manufacturing cost is increased.

In the case of the long distance transmission, the optical cable should be lengthened as much as the increased transmission distance, and therefore, the installation cost of the digital image transmitter is increased.

In addition, when the optical cable length is increased, there is every probability that a physical length of each optical fiber is varied to increase a generation probability of skew in the digital image signals, and therefore, an error generation probability of the digital image signals is also increased due to the skew generated. That is, in the case of the long distance transmission, there is a problem that reliability of the digital image signals is lowered.

### SUMMARY OF THE INVENTION

Therefore, the present invention is directed to provide a digital image transmitter capable of increasing reliability of digital image signals and reducing manufacturing and installation costs by transforming the digital image signals composed of four channel electrical signals, i.e., R, G, B and C, to a single channel of signal and transmitting the transformed single channel of signal.

According to an aspect of the present invention, a digital image transmitter includes: a sender for transforming a plurality of channels of electrical signals output from a computer to a single channel of optical signal and sending the single channel of optical signal; an optical cable for sending the single channel of optical signal of the sender through a single optical fiber; and a receiver for recovering the single channel of optical signal transmitted through the optical cable to the plurality of channels of electrical signals and outputting the electrical signals to a digital image display device.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a view illustrating a configuration of a conventional digital image transmitter;

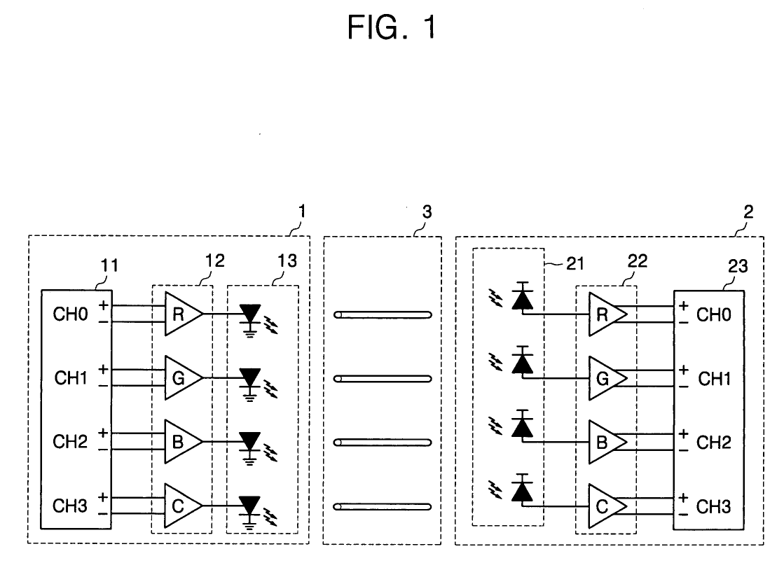

FIG. 2 is a view illustrating a configuration of a digital image transmitter in accordance with an embodiment of the present invention;

FIG. 3 is a view illustrating a configuration of a digital image transmitter in accordance with another embodiment of the present invention; and

FIG. 4 is a cross-sectional view of an optical cable in accordance with the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

Hereinafter, a digital image transmitter in accordance with the present invention will be described with reference to the accompanying drawings.

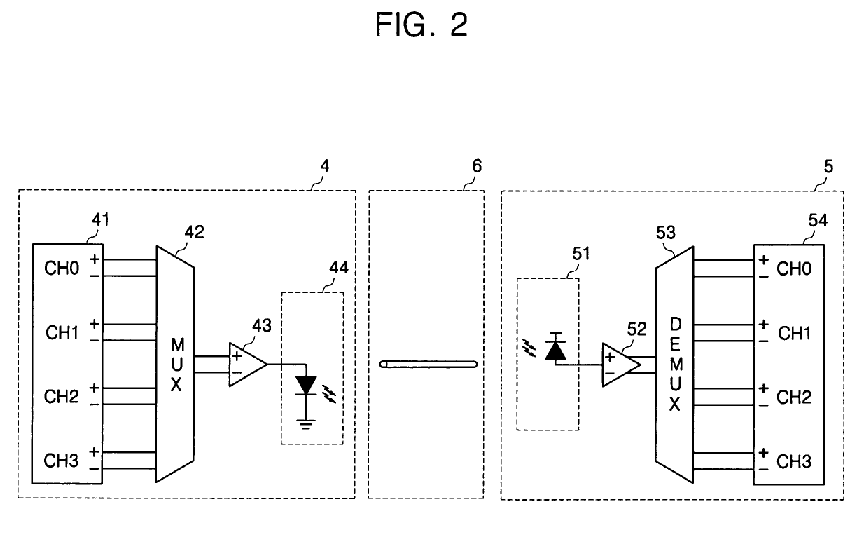

FIG. 2 is a view illustrating a configuration of a digital image transmitter in accordance with an embodiment of the present invention.

Referring to FIG. 2, the digital image transmitter in accordance with the present invention includes a sender 14 provided with a sending connector 41, a multiplexer (MUX or parallelizer-serializer) 42, a laser driver 43, and a laser diode 44; a receiver 5 provided with a photo diode 51, a signal amplifier 52, a demultiplexer (DEMUX or serializer-parallelizer) 53, and a receiving connector 54; and an optical cable 6 provided with a single optical fiber.

In this connection, the sending connector 41 and the receiving connector 42 are a standardized DVI connector.

The sending connector 41 of the sender 4 performs a physical connection to a computer 10, and receives four channel electrical signals transmitted from the computer 10, and transmits the received signals to the multiplexer 42.

The multiplexer 42 multiplexes the received four channel electrical signals to a single channel of signal, and the laser driver 43 turns on or off the laser diode 44 to generate a single channel of optical signal depending upon the multiplexed single channel of signal.

The aforementioned multiplexer 42 and the following demultiplexer 43 employ any one of various multiplexing methods such as a frequency division multiplexing method, a time division multiplexing method, and a statistical time division multiplexing method.

The single channel of optical signal is long distance transmitted through the single optical fiber 6 to be transmitted to the photo diode 51 of the receiver 5.

The photo diode 51 of the receiver 5 detects the optical signal transmitted through the optical fiber 6 to recover it to electrical signals. At this time, the recovered electrical signal has a very weak voltage of about several tens of μ Å.

The signal amplifier 52 receives the electrical signal applied from the photo diode 51, and amplifies a voltage level of the received electrical signal to a voltage level that the electrical signal can be recognized.

The demultiplexer 53 divides the amplified electrical signal into the four channel electrical signals, i.e., R, G, B and C, to recover to the original digital image signals, and to output each of the electrical signals to the corresponding channels.

The receiving connector 54 outputs the four channel electrical signals, i.e., R, G, B and C, received from each of the channels, respectively.

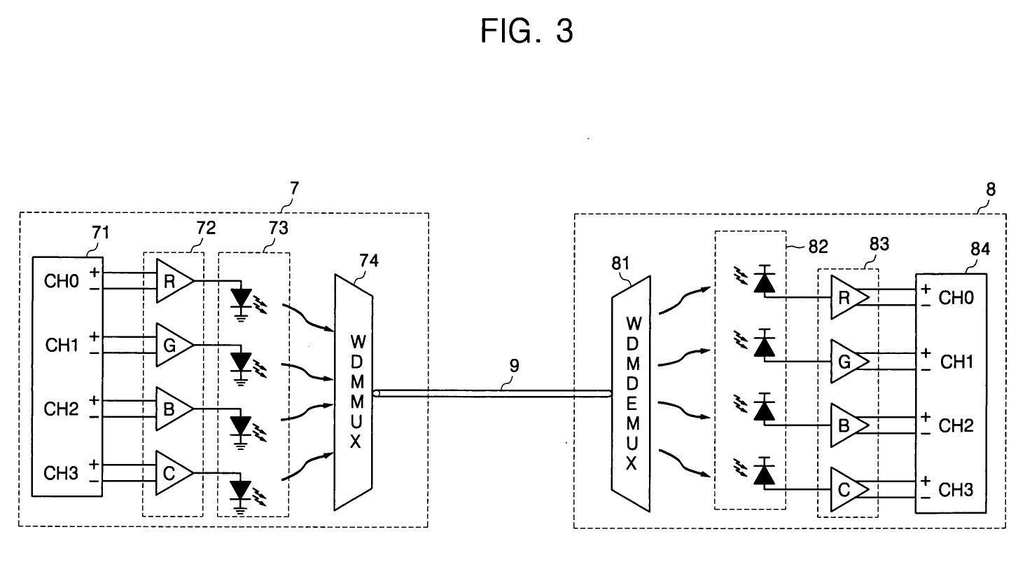

FIG. 3 is a view illustrating a configuration of a digital image transmitter in accordance with another embodiment of the present invention.

Referring to FIG. 3, the digital image transmitter in accordance with the present invention includes a sender 7 provided with a sending connector 71, four laser drivers 72, four laser diodes 73, and a wavelength division multiplexing MUX (WDMMUX) 74; a receiver 8 provided with a wavelength division multiplexing DEMUX (WDMDEMUX) 81, four photo diodes 82, four signal amplifiers 83, and a receiving connector 84; and an optical cable 9 provided with a single optical fiber.

The sending connector 71 of the sender 7 performs a physical connection to a computer 10 to receive four channel digital image signals transmitted from the computer 10 and transmit the signals to the laser drivers 72 of the corresponding channels.

Each of the laser drivers 72 turns on or off the laser diodes 73 to transform four channel electrical signals to four channel optical signals.

The wavelength division multiplexing MUX 74 multiplexes four wavelengths of the four channel optical signals generated through the four laser diodes 73 to transform the multiplexed signals to a single channel of optical signal, and outputs the single channel of optical signal to the single channel of optical fiber 9.

The wavelength division multiplexing DEMUX 81 of the receiver 8 divides the single channel of optical signal transmitted through the optical fiber 9 depending upon its wavelength to recover the single channel of optical signal to the four channel optical signals, and transmit the four channel optical signals to the photo diodes 82 of the corresponding channels.

Each of the photo diodes 82 recovers the optical signals to electrical signals having a weak voltage, and each of the signal amplifiers 83 amplifies the electrical signals to a voltage level that the LCD monitor 20 can recognize.

The receiving connector 84 combines the four channel electrical signals transmitted from the four signal amplifiers 83 to obtain digital image signals, and to output the digital image signals to the LCD monitor 20.

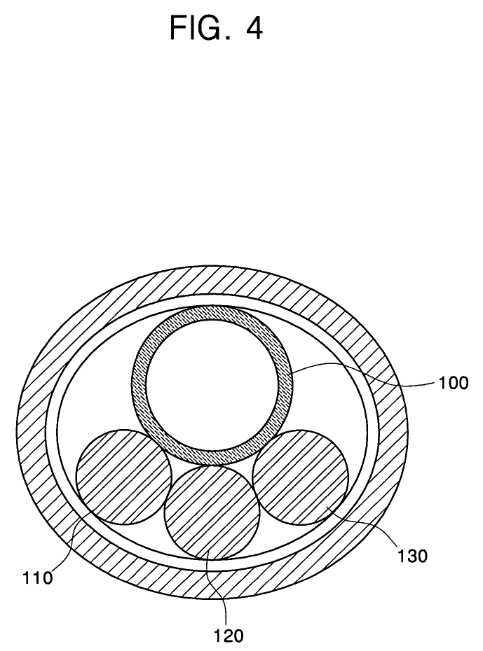

FIG. 4 is a cross-sectional view illustrating an optical cable in accordance with the present invention. Referring to FIG. 4, it will be apparent that the optical cable is provided with only a single optical fiber 100 to transmit digital image signals.

DVI type further includes a data display channel (DDC) signal for transmitting information of the LCD monitor 20 to the computer 10, and a hot plug detect (HPD) signal for checking a connecting state of the computer 10 and the LCD monitor 20 in addition to the digital image signals composed of four channel electrical signals such as R, G, B and C.

As shown, the optical cable further includes three electric wires 110, 120 and 130 for transmitting DDC data, DDC clock and HPD signal constituting the DDC signal, in addition to the single channel of optical fiber 100.

In addition, if necessary, the optical cable may further include two electric wires for transmitting a driving voltage and a ground voltage.

When these electric wires are optical fibers for supporting the DVI type, it is already known technology, so their descriptions will be omitted.

While the digital image transmitter of the present invention is described to be applied to the digital image transmitter for connecting the computer and the LCD monitor, it may be applied to various source for generating all digital image signals, and all digital image display devices for receiving the digital image signals and displaying them. Recently popularized digital image display devices may be a video wall, a large-sized LED (light emitting diode) electric signboard, or a plasma display panel (PDP).

Therefore, the digital image transmitter of the present invention is capable of simplifying a manufacturing process to increase productivity by using a single optical fiber during long distance transmission of the digital image signal consisting of four channel electrical signals, i.e., red (R), green (G), blue (B) and reference signal clock (C).

In addition, the digital image transmitter of the present invention is capable of reducing manufacturing and installation costs of the digital image transmitter by transmitting the digital image signals using only a single optical fiber.

Further, the digital image transmitter of the present invention is capable of stably transmitting a high-resolution digital image signal since the skew does not generated during long distance transmission.

As the foregoing illustrates, while the present invention is described with regard to specific embodiments, it is understood that changes may be made to the embodiments described above without departing from the broad inventive concepts thereof. Accordingly, the present invention is not limited to the particular embodiments disclosed, but is intended to cover all modifications that are within the spirit and scope of the invention, as defined by the appended claims.

1. A digital image transmitter comprising:
a sender for transforming a plurality of channels of electrical signals output from a computer to a single channel of optical signal and sending the transformed single channel of optical signal;
an optical cable for sending the single channel of optical signal of the sender through a single optical fiber; and
a receiver for recovering the single channel of optical signal transmitted through the optical cable to the plurality of channels of electrical signals and outputting the electrical signals to a digital image display device.

2. The digital image transmitter according to claim 1, wherein the sender comprises:
a sending connector performing a physical connection to the computer, and receiving the plurality of channels of electrical signals;
a multiplexer multiplexing the received plurality of channels of electrical signals to a single channel of electrical signal; and
a signal generator for driving a laser diode to generate the single channel optical signal depending upon the single channel of electrical signal.

3. The digital image transmitter according to claim 2, wherein the receiver comprises:
a photo diode detecting the single channel of optical signal transmitted through the optical fiber to generate the single channel of electrical signal;
a signal recovery part amplifying the single channel of electrical signal to enable the digital image display device to recognize the electrical signal, and recovering the single channel of electrical signal to the plurality of channels of electrical signals; and
a receiving connector performing a physical connection to the digital image display device, and outputting the plurality of recovered channel electrical signals to the digital image display device.

4. The digital image transmitter according to claim 3, wherein the signal recovery part comprises:
an amplifier amplifying the single channel of electrical signal to enable the digital image display device to recognize the electrical signal; and
a demultiplexer recovering the amplified single channel of electrical signal to the plurality of channels of electrical signals.

5. The digital image transmitter according to claim 1, wherein the sender comprises:
a sending connector performing a physical connection to the computer, and receiving the plurality of channels of electrical signals;
a signal generator for transforming the plurality of channels of electrical signals to the plurality of channels of optical signals; and
a multiplexer multiplexing the plurality of channels of optical signals to the single channel of optical signal using a wavelength division multiplexing method.

6. The digital image transmitter according to claim 5, wherein the signal generator comprises:
a plurality of laser drivers for driving laser diodes depending upon each channel electrical signal to generate each channel optical signal.

7. The digital image transmitter according to claim 5, wherein the receiver comprises:
a demultiplexer dividing the single channel of optical signal transmitted through the optical cable depending upon a wavelength of the signal to sort the divided signals to the plurality of channels of optical signals;
a signal recovery part recovering the plurality of channels of optical signals to the plurality of channels of electrical signals; and
a receiving connector performing a physical connection to the digital image display device, and outputting the plurality of recovered channel electrical signals to the digital image display device.

8. The digital image transmitter according to claim 7, wherein the signal recovery part comprises:
a plurality of photo diodes for transforming the plurality of channels of optical signals to the corresponding electrical signals, respectively; and
a plurality of amplifier for amplifying the plurality of channels of electrical signals to enable the digital image display device to recognize the electrical signals, respectively.

9. The digital image transmitter according to claim 1, wherein the optical cable further comprises three electric wires for transmitting data display channel (DDC) data, a data display channel (DDC) clock and a hot plug detect (HPD) signal.
